(19) United States
(12) Patent Application Publication
(10) Pub. No.: US 2025/0361895 A1
(43) Pub. Date: Nov. 27, 2025

(54) CLIP ENGAGEMENT STRUCTURE AND SEPARATOR ATTACHMENT STRUCTURE

(71) Applicant: SUBARU CORPORATION, Tokyo (JP)

(72) Inventor: Masanori TANAKA, Tokyo (JP)

(73) Assignee: SUBARU CORPORATION, Tokyo (JP)

(21) Appl. No.: 19/203,238

(22) Filed: May 9, 2025

(30) Foreign Application Priority Data
May 23, 2024 (JP) 2024-084210

(51) Int. Cl. F16B 5/06; B60R 13/02

(52) U.S. Cl. CPC F16B 5/0621; B60R 13/0206

(57) ABSTRACT

A clip engagement structure includes: a clip hole in a panel; and an engagement clip in the clip hole, including a base contacting one surface of the panel, a main body permanently affixed with the base, protruding from the clip hole to another surface, and locking claws provided at ends of the main body, penetrate the clip hole, and hooked to the other surface. Ends of the locking claws near the base are elastically deformable toward the ends of the main body in which side surfaces on a side orthogonal to a line coupling the locking claws have different shapes and are symmetrical on the end sides across a center of the main body. In the clip hole, parts allowing passing of the side surfaces are a similar in shape, and the locking claws are allowed to pass through parts by elastic deformation the locking claws.

### CROSS-REFERENCE TO RELATED APPLICATIONS

The present application claims priority from Japanese Patent Application No. 2024-084210 filed on May 23, 2024, the entire contents of which are hereby incorporated by reference.

### BACKGROUND OF THE INVENTION

### Field of the Invention

The disclosure relates to a clip engagement structure and a separator attachment structure.

### Description of Background Art

Japanese Unexamined Patent Application Publication No. 2000-271934 describes a separator (partition) that holds a plate-shaped foamable base material having an outer shape similar to a shape of a closed cross section of a vehicle body frame member by a holder plate. The entire contents of this publication are incorporated herein by reference.

### SUMMARY OF THE INVENTION

According to one aspect of the disclosure, a clip engagement structure includes a panel having a clip hole bored therein, and an engagement clip mounted in the clip hole and including a base that contacts a first surface of the panel, a main body permanently affixed with the base and protruding from the clip hole to a second surface of the panel, and locking claws that are positioned at ends of the main body, penetrate the clip hole and are hooked to the second surface of the panel such that ends of the locking claws on a side of the base are elastically deformable in a direction of the ends of the main body. The main body has side surfaces having different shapes on a side orthogonal to a line coupling the locking claws and formed symmetrically on respective sides of the ends of the main body across a center in the direction of the ends of the main body, and the clip hole of the panel has parts through which the side surfaces of the main body pass respectively are similar in shape, and parts through which the locking claws of the engagement clip respectively pass each have a size that allows a corresponding one of the locking claws to pass through by elastically deforming the corresponding one of the locking claws.

According to another aspect of the disclosure, a separator attachment structure includes a frame member that joins the panel in the clip engagement structure described in the foregoing aspect and another panel such that a hollow closed cross section is formed, and a separator including the engagement clip in the clip engagement structure and housed in the closed cross section. The separator includes a plate main body that partitions the closed cross section, and a foamable base material held by the plate main body, the plate main body is positioned on a side opposite to the main body of the base of the engagement clip, and the foamable base material receives heat from the outside and foams to close the closed cross section.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view illustrating a schematic structure of a vehicle body;

FIG. 2 is a perspective view of a separator;

FIG. 3A is a cross-sectional view of A of FIG. 1 as viewed from the rear of the vehicle body;

FIG. 3B is a cross-sectional view corresponding to FIG. 3A illustrating a state where a foamable base material of the separator is foamed;

FIG. 4A is a side view of FIG. 3A as viewed from a side of an inner panel;

FIG. 4B is a side view of A′ of FIG. 1 as viewed from the side of the inner panel;

FIG. 5A is a side view of B of FIG. 1 as viewed from the side of the inner panel; and

FIG. 5B is a side view of B′ of FIG. 1 as viewed from the side of the inner panel.

### DETAILED DESCRIPTION OF THE EMBODIMENTS

Embodiments will now be described with reference to the accompanying drawings, wherein like reference numerals designate corresponding or identical elements throughout the various drawings.

The following description is an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis.

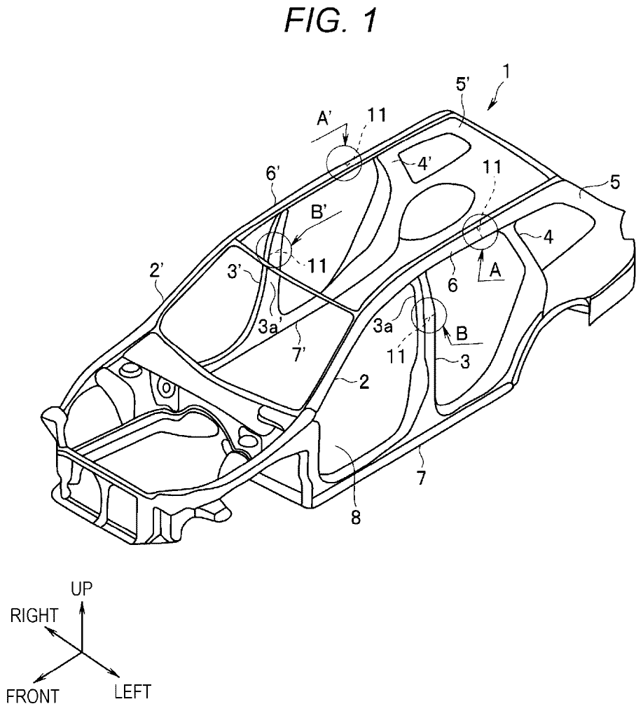

A vehicle body 1 illustrated in FIG. 1 is a white body. The white body is a vehicle body before electrodeposition coating in which vehicle body assembly is completed. The vehicle body 1 has a monocoque structure obtained by permanently joining panel members and vehicle body frame members. The vehicle body frame members are provided substantially symmetrically on both left and right sides of the vehicle body 1. In each vehicle body frame member, a hollow closed cross section is provided by joining an inner panel and an outer panel.

The vehicle body frame members disposed on both the sides of the vehicle body 1 include pillars extending in a vertical direction of the vehicle body 1. The pillars include left and right front pillars (A pillars) 2 and 2′, center pillars (B pillars) 3 and 3′, quarter pillars (C pillars) 4 and 4′, and rear pillars (D pillars) 5 and 5′. Examples of the vehicle body frame members further include roof side rails 6 and 6′ and side sills 7 and 7′ disposed on the left and right of the vehicle body 1.

The roof side rails 6 and 6′ couple upper ends of the pillars 2 to 5 and 2′ to 5′, and extend in a front-rear direction of the vehicle body 1. The side sills 7 and 7′ are lower edges of door openings included in the vehicle body 1, are joined to both ends of a floor panel 8 in a vehicle width direction, and extend in the front-rear direction of the vehicle body 1. In the following description, the pillars 2 to 5, 2′ to 5′, the roof side rails 6 and 6′, and the side sills 7 and 7′ may be collectively referred to as the vehicle body frame members.

A separator is interiorly included in each of the vehicle body frame members 2 to 7 and 2′ to 7′. The separators are attached to the inner panel before the vehicle body frame members 2 to 7 and 2′ to 7′ are provided in an assembly process.

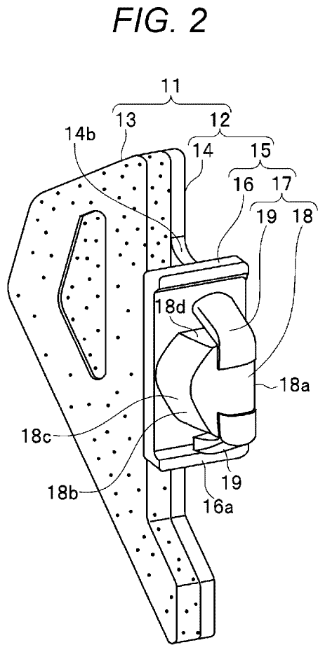

FIG. 2 illustrates a configuration of a separator 11. The separator 11 mounted to the roof side rails 6 and 6′ as examples of the vehicle body frame member is illustrated as a representative example. The separator 11 is mounted at the same position of the roof side rails 6 and 6′ provided bilaterally symmetrically. Therefore, shapes of closed cross section of the roof side rails 6 and 6′ at the position where the separator 11 is mounted are symmetrical. The same separator 11 is mounted to the left and right roof side rails 6 and 6′.

The separator 11 includes a holder plate 12 and a foamable base material 13. The foamable base material 13 has a flat plate shape having a desired plate thickness by injection molding or the like. The foamable base material 13 includes a foamable material mixed with a foaming agent. The foamable base material 13 foams by heat from the outside and expands to be a closed cell foam.

The holder plate 12 include heat-resistant synthetic resin (thermoplastic synthetic resin), and is provided by, for example, injection molding. The holder plate 12 includes a plate main body 14 and an engagement clip 15. The engagement clip 15 includes a base 16 and a clip 17.

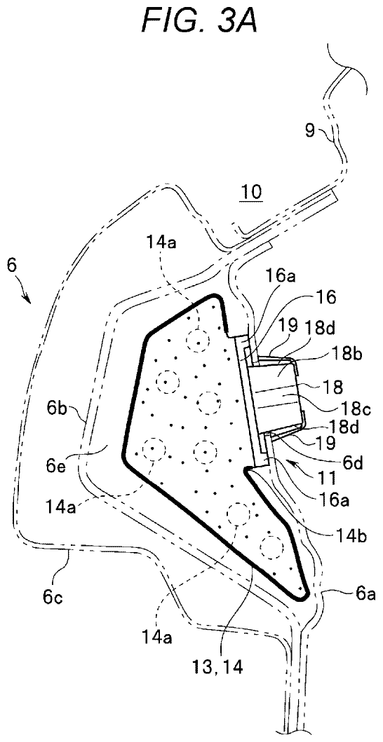

The plate main body 14 and the foamable base material 13 have the same outer shape. The outer shapes of the plate main body 14 and the foamable base material 13 are provided in shapes similar to inner peripheries of the roof side rails 6 and 6′ to which the plate main body 14 and the foamable base material 13 are mounted. The foamable base material 13 is fixed in a state of being in surface contact with the plate main body 14. Holding tacks 14a (see FIG. 3A) are provided in a protruding manner on a surface of the plate main body 14 to which the foamable base material 13 is attached. On the other hand, holding holes (not illustrated) are bored in the foamable base material 13 at positions corresponding to the holding tacks 14a. The foamable base material 13 is held and fixed by press-fitting the holding holes into the holding tacks 14a.

A back surface of the base 16 is permanently affixed with a plate thickness surface of the plate main body 14 via a neck 14b. The base 16 has a rectangular shape in plan view, and is disposed in parallel with the plate thickness surface of the plate main body 14. Therefore, the plate main body 14 and the base 16 are substantially T-shaped when viewed from a lower surface of FIG. 2.

A long side of the base 16 is disposed in a direction orthogonal to a plate thickness direction of the plate main body 14. A short side of the base 16 is disposed in the plate thickness direction of the plate main body 14. A back surface at the center in a short side direction of the base 16 is supported by the neck 14b.

Legs 16a are provided at ends of a front surface of the base 16 in a long side direction. The legs 16a are brought into contact with an inner surface of a rail side inner panel 6a (to be described later) of the roof side rail 6 (6′). The clip 17 is provided on the surface of the base 16. The clip 17 has a main body 18 and locking claws 19. The main body 18 is provided in a protruding manner from the center of the base 16.

As illustrated in FIGS. 2, 3, and 4A, the main body 18 has a symmetrical shape in the long side direction and an asymmetrical shape in the short side direction of the base 16. For example, in the main body 18, a plane 18a is provided on one side surface in the short side direction of the base 16. In the main body 18, an isosceles member 18b is provided on the other side surface in the short side direction of the base 16. The isosceles member 18b is inclined from an apex 18c in the long side direction of the base 16 so as to approach the plane 18a. The apex 18c is provided on a round surface having a predetermined curvature.

The plane 18a and the isosceles member 18b have symmetrical shapes in the long side direction of the base 16 across the center of the main body 18. In the main body 18, flat surfaces 18d are provided at symmetrical positions in the long side direction of the base 16 across the center of the main body 18. The flat surfaces 18d have shapes obtained by cutting both ends of the main body 18 in parallel.

The pair of locking claws 19 is provided on sides of both the flat surfaces 18d of the main body 18. The locking claws 19 extend in a direction from an upper surface of the main body 18 toward the base 16. Sides of lower ends of the locking claws 19 are inclined in a direction spreading from upper parts. The lower ends of the locking claws 19 are elastically deformable in a direction approaching both the flat surfaces 18d.

Here, a configuration of the roof side rail 6 on the left side of the vehicle body 1 will be briefly described with reference to FIG. 3A. The roof side rail 6 illustrated in FIG. 3A is provided by viewing A of FIG. 1 from the rear to the front of the vehicle body 1 in a cross section in the vehicle width direction.

In the roof side rail 6, a hollow closed cross section 6e is obtained by joining the rail side inner panel (hereinafter, referred to as an “inner panel”) 6a and a reinforcement rail side outer panel (hereinafter, referred to as an “outer panel”) 6b.

The inner panel 6a is disposed on an inner side in the vehicle width direction (vehicle interior side). The outer panel 6b is disposed on an outer side in the vehicle width direction (vehicle exterior side). The vehicle exterior side of the outer panel 6b is covered with a side outer panel 6c. An upper side of the outer panel 6b and a side of a roof top panel 9 in the vehicle width direction are surface-joined to each other by a so-called mohican groove 10.

As illustrated in FIG. 3A, the separator 11 is housed in the closed cross section 6e provided by the inner panel 6a and the outer panel 6b.

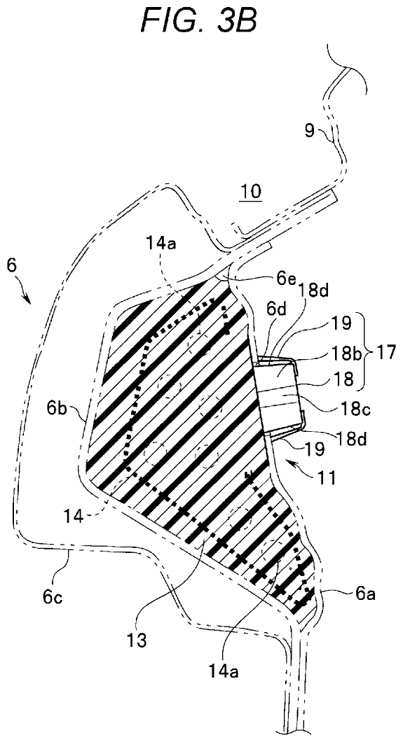

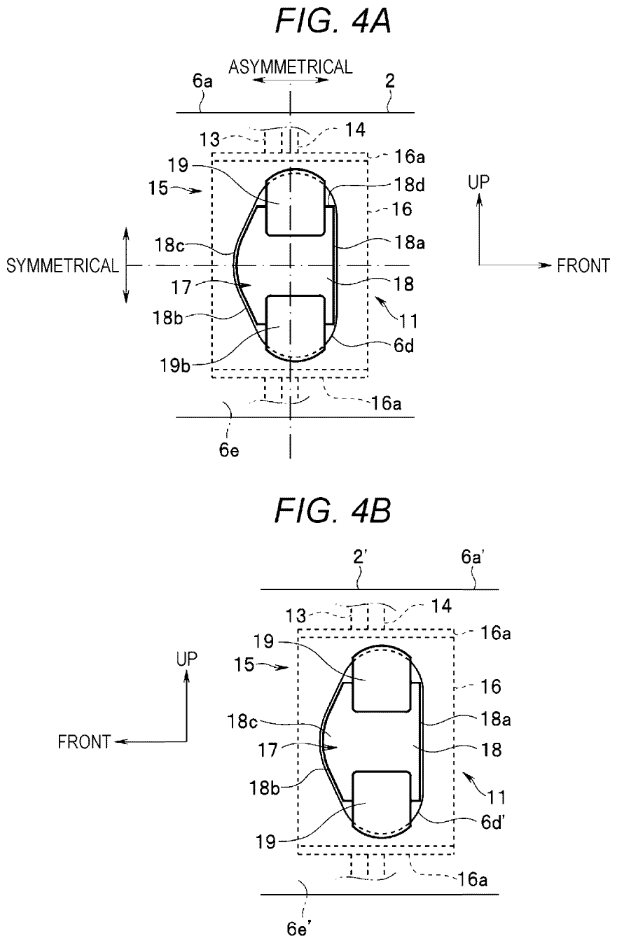

A clip hole 6d that allows penetration of the clip 17 of the separator 11 is bored in the inner panel 6a. As illustrated in FIG. 4A, the clip hole 6d is provided such that parts corresponding to the plane 18a and the isosceles member 18b of the main body 18 have shapes similar to the shapes of the plane 18a and the isosceles member 18b with slight gaps.

The plane 18a is provided on a front side of the vehicle body 1 with respect to the inner panel 6a. The isosceles member 18b is provided on a rear side of the vehicle body 1 with respect to the inner panel 6a. The clip hole 6d has a shape that allows penetration of parts corresponding to the locking claws 19 of the main body 18 by elastically deforming the locking claws 19. An outer periphery of the locking claw 19 has an arc shape.

The clip hole 6d corresponding to the locking claw 19 has a shape in which the lower ends of the locking claws 19 are hooked to the outside of the clip hole 6d in a normal state where no external force is applied to the locking claws 19. In other words, outer edges of the clip hole 6d corresponding to the lower ends of the locking claws 19 are provided in similar shapes smaller than the outer peripheries of the locking claws 19. Therefore, as illustrated in FIG. 4A, the clip hole 6d has an isosceles triangle shape with corners having arc shapes so as to penetrate (pass) the clip 17.

FIG. 3A illustrates a state where the clip 17 of the separator 11 is fixed to the clip hole 6d of the inner panel 6a by being penetrated (passed) from the inside. In this state, the legs 16a provided to the base 16 are in contact with the inner surface of the inner panel 6a. The locking claws 19 of the clip 17 are hooked to the outer edges of the clip hole 6d in an outer surface of the inner panel 6a. Gaps corresponding to a plate thickness of the inner panel 6a are provided between upper surfaces of the legs 16a and lower end surfaces of the locking claws 19.

FIG. 4B illustrates a clip hole 6d′ bored in an inner panel 6a′ of the roof side rail 6′ on the right side of the vehicle body 1. Closed cross sections provided by the inner panels 6a and 6a′ and the outer panel 6b and an outer panel 6b′ at positions where the separators 11 are mounted have symmetrical shapes. The clip hole 6d′ bored in the inner panel 6a′ on the right side is provided so as to be opposite in the front-rear direction to the clip hole 6d bored in the inner panel 6a on the left side. In other words, the clip hole 6d is bored in a shape reversed by 180° with respect to an extension direction of a frame including the inner panels 6a and 6a′ and the outer panels 6b and 6b′.

When the clip 17 of the separator 11 is mounted in accordance with a direction of the clip hole 6d′, the separator 11 is fixed in a state of being symmetrical with the separator 11 mounted to the roof side rail 6 on the left side. In this case, when the cross-sectional view illustrated in FIG. 3A is applied to the roof side rail 6′ on the right side, the cross-sectional view corresponds to a state where A′ of FIG. 1 is viewed from the front to the rear of the vehicle body 1 in a cross section in the vehicle width direction.

Therefore, the separator 11 can be shared by the left and right roof side rails 6 and 6′. The clip 17 of the separator 11 has an asymmetrical shape in the plate thickness direction of the plate main body 14. Therefore, an attachment direction is not mistaken. When the separator 11 is reversed by 180°, an attachment surface of the foamable base material 13 is reversed in the front-rear direction at the left and right roof side rails 6 and 6′. However, the foamable base material 13 foams and expands in the closed cross section to close a periphery of the plate main body 14. Therefore, a foaming position of the foamable base material 13 is not greatly shifted.

The plate main body 14 and the foamable base material 13 of the separator 11 are provided in accordance with the shapes of the closed cross sections at the positions where the vehicle body frame members 3 to 7 are mounted. On the other hand, the clip 17 of the engagement clip 15 is provided in a different shape at each of positions where the vehicle body frame members 3 to 7 are mounted. In this case, the main body 18 of the clip 17 is common in that the main body 18 has the symmetrical shape in the long side direction and the asymmetrical shape in the short side direction of the base 16.

In the present embodiment, the main body 18 is also common in that the plane 18a is provided on the one side surface in the short side direction of the base 16 and the isosceles member 18b is provided on the other side surface in the short side direction of the base 16. It is also common in that the apex 18c is provided on the round surface having the predetermined curvature.

On the other hand, it is also common in that the shapes of the clip holes 6d and 6d′ bored in the inner panels of the vehicle body frame members 3 to 7 and 3′ to 7′ are similar to an outer diameter of the clip 17.

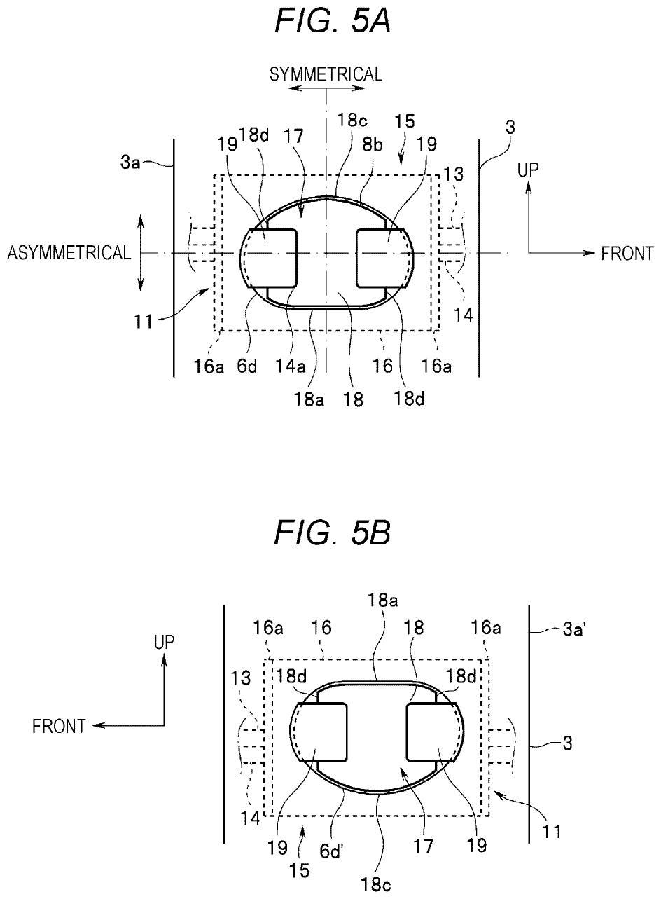

For example, FIGS. 5A and 5B exemplify the separators 11 mounted at the same positions of the left and right center pillars 3 and 3′, and the clip holes 6d and 6d′ bored in inner panels 3a and 3a′. The same reference numerals are given to parts common to those of FIGS. 4A and 4B to simplify the description.

The plate main body 14 and the foamable base material 13 of the separator 11 are provided in a shape similar to a shape of a hollow closed cross section provided by the inner panel 3a and an outer panel (not illustrated) of the center pillar 3. The clip 17 of the engagement clip 15 has a shape different from the shapes of the clips 17 attached to the roof side rails 6 and 6′. Therefore, the clip holes 6d and 6d′ bored in the inner panels 3a and 3a′ also have shapes different from the shapes of the clip holes 6d and 6d′ bored in the inner panel 6a of the roof side rail 6.

The clip holes 6d and 6d′ bored in the inner panels 3a and 3a′ of the center pillars 3 and 3′ have the shapes that are reversed in the vertical direction, such as the shapes reversed by 180°, or the like.

For example, a distance between the plane 18a and the isosceles member 18b of the main body 18 is set longer than a distance between the plane 18a and the isosceles member 18b of the main body 18 illustrated in FIG. 4A. The isosceles member 18b has a shape having a curvature as a whole. As a result, the attachment direction of the separator 11 is one direction. Therefore, it is possible to avoid misassembly of the separator 11 attached to the center pillars 3 and 3′ and the separator 11 attached to the roof side rails 6 and 6′.

The shapes of the main body 18 of the separator 11 and the clip holes 6d (6d′) of an inner frame are set to different shapes for different attachment parts. As a result, physical misassembly is avoided. Therefore, for example, even when an operator accidentally drops the separator 11, it is possible to easily identify which of the clip holes 6d and 6d′ the separator 11 is to be mounted to.

Next, an action of the separator 11 having such a configuration will be described by exemplifying a case where the separator 11 is attached to the roof side rail 6.

The separator 11 is attached in the assembly process before the outer panel 6b is joined to the inner panel 6a of the roof side rail 6. In other words, the clip 17 of the separator 11 permanently affixed in advance is mounted in the clip hole 6d bored in the inner panel 6a from the inside. In the present embodiment, the separator 11 is attached to the inner panel 6a by the clip 17. Therefore, when the holder plate 12 of the separator 11 is attached to the inner panel 6a, the separator 11 is not heated. Therefore, it is possible to avoid accidental foaming of the foamable base material 13.

In the main body 18, the front-rear direction of the vehicle body 1 is asymmetrical and the vertical direction orthogonal to the front-rear direction is symmetrical. The main body 18 of the clip 17 and the clip hole 6d have the similar shapes. Therefore, when a mounting direction of the separator 11 attached to the left and right roof side rails 6 and 6′ is wrong, it is difficult to physically attach the separator. Therefore, misassembly can be avoided in advance.

The shape of the main body 18 is different for each attachment part. Therefore, it is possible to avoid misassembly for each attachment part in advance. The common separator 11 is used at the bilaterally symmetrical attachment parts. Therefore, cost reduction due to sharing of the component can be implemented.

The inner panel 6a and the outer panel 6b are joined to each other in a predetermined manner to provide a hollow closed cross section inside. Similarly, in each of the other vehicle body frame members 3 to 7, the separator 11 is mounted to the inner panel in a predetermined manner, and then the inner panel and the outer panel are joined to provide a hollow closed cross section.

The vehicle body 1 (see FIG. 1) assembled in a predetermined manner is subjected to electrodeposition coating, and the foamable base material 13 of each separator 11 is foamed and expanded using heat received from the outside in the subsequent drying process (baking process). As a result, a gap around the holder plate 12 in the closed cross section is closed.

The separator 11 is interiorly included in the closed cross section where the inner panel and the outer panel are welded to each other. Thus, it is difficult to confirm whether the separator 11 is correctly attached after the assembly of the vehicle body 1 is completed. However, in the present embodiment, the shape of the clip 17 of the separator 11 is different for each attachment part of the corresponding vehicle body frame members 2 to 7. Therefore, misassembly is avoided. Therefore, the gap around the plate main body 14 in the closed cross section of each of the vehicle body frame members 2 to 7 can be reliably closed by the foaming of the foamable base material 13.

Therefore, for example, when a hole unnecessary after the assembly process is bored in the panel at the part where the foamable base material 13 is foamed, the hole is closed by the foaming of the foamable base material 13. Therefore, airtightness can be maintained.

The separators 11 are reversed by 180° and attached to the attachment parts of the other vehicle body frame members 2′ to 7′. Therefore, cost reduction due to sharing of the components can also be implemented.

In the present embodiment, one separator 11 is provided with one clip 17. The shape of the main body 18 included in the clip 17 is different for each attachment part. On the other hand, the clip holes 6d and 6d′ on the non-mounting sides have the shapes corresponding to the shape of the clip 17. Therefore, misassembly can be avoided.

One clip 17 is intended to have a different shape according to the attachment part. Therefore, a degree of freedom in design is increased, and an optimum shape can be selected. Each of the clip holes 6d and 6d′ provided on the non-mounting side is provided at one place. Therefore, molding is facilitated, and a production cost can be reduced.

The main body 18 of the clip 17 is positioned with respect to the clip holes 6d and 6d′ by the plane 18a and the isosceles member 18b. Therefore, a sliding surface for positioning the main body 18 and the clip holes 6d and 6d′ is small. One clip 17 is provided for one separator 11. From these, it is easy to manufacture molds (injection molds or press molds) for molding the main body 18 and the clip holes 6d and 6d′. Therefore, it is possible to reduce a cost for investment in the molds.

The disclosure is not limited to the embodiment described above. For example, the separator 11 can be applied to any vehicle body frame member of the vehicle body 1 as long as the shape of the main body 18 satisfies the following conditions, and the clip holes 6d and 6d′ corresponding to the main body 18 and the clip 17 are provided on the side of the inner panel.
1) The plane 18a is provided on the one side surface of the main body 18, and the isosceles member 18b is provided on the other side surface.
2) The plane 18a and the isosceles member 18b have the symmetrical shapes across a line coupling the centers of the plane 18a and the isosceles member 18b.

According to the embodiment of the disclosure, an engagement clip to be mounted in a clip hole of a panel includes a base, a main body, and locking claws. The base contacts one surface of the panel. The main body protrudes from the clip hole to the other surface of the panel. The locking claws are hooked to the other surface of the panel. In the main body, both side surfaces on sides orthogonal to a line coupling both the locking claws are provided in different shapes. The side surfaces are provided symmetrically on sides of ends across a center in a direction of both ends of the main body. In the clip hole, a part through which each side surface passes is provided in a similar shape. Therefore, an operator can easily visually identify the engagement clip corresponding to the clip hole. An assembly direction is one direction. Therefore, misassembly can be avoided.

There has been a technique of filling a foaming agent into a vehicle body frame member of a closed cross section for improving sound insulation in a vehicle interior and avoiding foreign matters such as rainwater and dust from entering the vehicle interior from the outside. In the vehicle body frame member, a separator in which a foamable base material before foaming is held by a holder plate (also referred to as “carrier”) is fixed. The foamable base material is foamed and expanded by using heating received from the outside in a drying process (baking process) after electrodeposition coating of a vehicle body.

For example, Japanese Unexamined Patent Application Publication No. 2000-271934 describes a separator (partition) that holds a plate-shaped foamable base material having an outer shape similar to a shape of a closed cross section of a vehicle body frame member by a holder plate. The separator is attached before an inner panel and an outer panel constituting the vehicle body frame member are joined in an assembly process of a vehicle body.

One place of an outer edge of the holder plate is provided with an engagement clip. The engagement clip is engaged with an engagement hole on a side of the inner panel to position and fix the separator in the inner panel. The separator is accommodated in the vehicle body frame member obtained by joining the inner panel and the outer panel, so as to block a hollow part of the closed cross section. When heat from the outside is applied to the separator in a drying process after electrodeposition coating, the foamable base material is foamed, and a gap around the holder plate is closed. The entire contents of this publication are incorporated herein by reference.

An aspect of the disclosure provides a clip engagement structure. The clip engagement structure includes a clip hole and an engagement clip. The clip hole is bored in a panel. The engagement clip is mounted in the clip hole. The engagement clip includes a base, a main body, and locking claws. The base contacts one surface of the panel. The main body is permanently affixed with the base and protrudes from the clip hole to another surface of the panel. The locking claws are provided at both ends of the main body, penetrate the clip hole, and are hooked to the other surface of the panel. Ends of the locking claws on a side of the base are elastically deformable in a direction of the ends of the main body. In the main body, both side surfaces on a side orthogonal to a line coupling both the locking claws have different shapes. The side surfaces are provided symmetrically on respective sides of the ends of the main body across a center in the direction of the ends of the main body. In the clip hole, parts through the side surfaces pass respectively are similar in shape. Parts through which the locking claws respectively pass each have a size that allows a corresponding one of the locking claws to pass through by elastically deforming the corresponding one of the locking claws.

An aspect of the disclosure provides a separator attachment structure. The separator attachment structure includes a frame member and a separator. In the frame member, the panel according to the above aspect and another panel are joined to provide a hollow closed cross section. The separator includes the engagement clip according to the above aspect and is housed in the closed cross section. The separator includes a plate main body and a foamable base material. The plate main body partitions the closed cross section. The foamable base material is held by the plate main body. The plate main body is provided on a side opposite to the main body of the base provided to the engagement clip. The foamable base material receives heat from the outside and then foams to close the closed cross section.

The separator is attached to the side of the inner panel before the inner panel and the outer panel are joined in the assembly process of the vehicle body. The separator is often attached to the inner panel by an operator. Even when the operator erroneously assembles the separator, it is difficult to be confirmed after the inner panel and the outer panel are joined.

There are various frame members such as a roof side rail, a center pillar, and a side sill as the vehicle body frame members interiorly including the separators. The separators may be interposed at predetermined intervals among these vehicle body frame members. The shapes of the closed cross sections of the vehicle body frame members among which the separators are interposed are individually different. Therefore, the separators of several tens of different shapes are used for one vehicle body. The operator uses a skill to grasp the shapes of all the separators and correctly attach the separators.

Therefore, the engagement clips may be provided to the holder plate, and the number, interval, and direction of the engagement clips may be changed for each type. By changing the number, interval, and direction of the engagement clips for each type, when it is difficult to mount the engagement clips in the engagement holes, the operator can immediately recognize that misassembly occurs.

However, in a state where the separator is interiorly included in the vehicle body frame member, the engagement clips protrude to the outside of the inner panel. Electric wiring and various structures are disposed on an outer surface of the inner panel. A layout of the engagement clips is considered so as not to interfere with the electric wiring and the structures. As a result, the layout of the engagement clips is limited, and minute changes are made for each type, which makes it difficult for the operator to perform visual identification.

It is desirable to provide a clip engagement structure and a separator attachment structure that not only allow an operator to easily visually identify a corresponding component at the time of assembly but also avoid misassembly

Obviously, numerous modifications and variations of the present invention are possible in light of the above teachings. It is therefore to be understood that within the scope of the appended claims, the invention may be practiced otherwise than as specifically described herein.

1. A clip engagement structure, comprising:
a panel having a clip hole bored therein; and
an engagement clip mounted in the clip hole and comprising a base configured to contact a first surface of the panel, a main body permanently affixed with the base and protruding from the clip hole to a second surface of the panel, and a plurality of locking claws positioned at ends of the main body and configured to penetrate the clip hole and be hooked to the second surface of the panel such that ends of the locking claws on a side of the base are elastically deformable in a direction of the ends of the main body,
wherein the main body has side surfaces having different shapes on a side orthogonal to a line coupling the locking claws and formed symmetrically on respective sides of the ends of the main body across a center in the direction of the ends of the main body, and the clip hole of the panel has parts through which the side surfaces of the main body pass respectively are similar in shape, and parts through which the locking claws of the engagement clip respectively pass each have a size that allows a corresponding one of the locking claws to pass through by elastically deforming the corresponding one of the locking claws.

2. The clip engagement structure according to claim 1, wherein one of the side surfaces of the main body is plane, and another one of the side surfaces is isosceles.

3. A separator attachment structure, comprising:
a frame member configured to join the panel in the clip engagement structure of claim 1 and another panel such that a hollow closed cross section is formed; and
a separator comprising the engagement clip in the clip engagement structure and housed in the closed cross section,
wherein the separator comprises a plate main body configured to partition the closed cross section, and a foamable base material held by the plate main body, the plate main body is positioned on a side opposite to the main body of the base of the engagement clip, and the foamable base material is configured to receive heat from the outside and foam to close the closed cross section.

4. The separator attachment structure according to claim 3, wherein the frame member is provided in a pair such that the pair of frame members is disposed to face each other and that parts of the clip hole in the panel of each of the frame members through which the side surfaces of the main body pass respectively are reversed with respect to an extension direction of each of the frame members.

5. The separator attachment structure according to claim 3, wherein the main body of the engagement clip has a different shape for a different shape of the closed cross section of a part attached to each of the frame members.
